(19) United States
(12) Patent Application Publication
(10) Pub. No.: US 2025/0207336 A1
(43) Pub. Date: Jun. 26, 2025

(54) GROUND PROCESSING MACHINE AND METHOD FOR OPERATING A GROUND PROCESSING MACHINE

(71) Applicant: Hamm AG, Tirschenreuth (DE)

(72) Inventor: Hans-Peter PATZNER, Tirschenreuth (DE)

(21) Appl. No.: 18/985,231

(22) Filed: Dec. 18, 2024

(30) Foreign Application Priority Data
Dec. 20, 2023 (DE) 10 2023 135 898.7

(51) Int. Cl. E01C 19/00; E01C 19/26

(52) U.S. Cl. CPC E01C 19/004; E01C 19/26

(57) ABSTRACT

A self-propelled ground processing machine includes a steering system with a steering element to be actuated by an operator and at least one steering actuator, as well as a control arrangement for controlling at least one steering actuator on the basis of an actuation of the steering element. The control arrangement is designed to generate path information representing the path covered during the movement of the ground processing machine in the first direction of movement when the ground processing machine moves in a first direction of movement, and to control the at least one steering actuator on the basis of the path information when the ground processing machine moves in a second direction of movement substantially opposite to the first direction of movement.

The present invention relates to a self-propelled ground processing machine designed, for example, as a ground compactor, and to a method for operating a self-propelled ground processing machine when carrying out a ground processing operation.

When carrying out ground processing operations, it is often necessary to move a ground processing machine repeatedly back and forth on the ground to be processed in essentially opposite directions of movement. For example, when compacting asphalt material, it is necessary to achieve a predetermined, essentially uniform degree of compaction by repeatedly driving over the applied asphalt material.

Ground processing machines are generally constructed in such a way that a seat or/and a working station for an operator are positioned in an operating station in such a way that the operator is oriented in a predetermined direction, generally in the direction of forward travel of the ground processing machine, during operation of a ground processing machine. When such a ground processing machine is moved in the opposite direction, for example in reverse, the operator must, on the one hand, operate the actuating elements designed for forward travel, for example a steering element for steering the ground processing machine and a drive element for specifying the driving speed of the ground processing machine, but, on the other hand, look in the current direction of travel, for example the reverse direction, in order to be able to see the ground to be processed and, accordingly, in particular, to be able to operate the steering element in a suitable manner.

It is the object of the present invention to provide a ground processing machine, in particular a ground compactor, and a method for operating a ground processing machine, with which ground processing operations requiring movement of the ground processing machine in mutually opposite directions of movement can be carried out more easily and with greater precision.

According to a first aspect of the present invention, this object is achieved by a self-propelled ground processing machine, in particular ground compactor, comprising:
a steering system with a steering element to be operated by an operator and at least one steering actuator,
a control arrangement for controlling the at least one steering actuator on the basis of an actuation of the steering element,

wherein the control arrangement is designed to:
when the ground processing machine moves in a first direction of movement, generate path information representing the path covered when the ground processing machine moves in the first direction of movement,
when the ground processing machine moves in a second direction of movement substantially opposite to the first direction of movement, control the at least one steering actuator on the basis of the path information.

The ground processing machine constructed according to the invention is basically designed in such a way that its steering takes place on the basis of the manipulation of a steering element, for example a steering wheel, carried out by an operator. During the execution of a ground processing operation performed according to the steering instructions of an operator, the path traveled can be recorded and used as a reference for a steering operation carried out automatically by the control measures of the control arrangement during a subsequent movement of the ground processing machine in the opposite direction.

This means, for example, that during the forward travel of a ground processing machine an operator steers and during the reverse travel of the ground processing machine following the forward travel the control arrangement steers using the distance covered during the forward travel as a reference. By using this reference in an automated steering process, it is possible to steer the ground processing machine precisely, for example when reversing, and thus to carry out the ground processing process to be carried out with greater precision. This provides significant physical relief for the operator.

The ground processing machine may comprise a position detection system for providing position information representing a position of the ground processing machine during a movement of the ground processing machine, and the control arrangement may be designed to generate the path information based on the position information,

For precise detection of the position of the ground processing machine, the position detection system can be designed to generate the position information by communication with a radio-based position identification system. Such a radio-based position identification system can, for example, operate with satellite support or/and can use a radio system installed in the area of a construction site and generate corresponding position signals.

Alternatively or additionally, the control arrangement can be designed to generate the path information on the basis of steering information representing a steering state of the ground processing machine, preferably steering angle information, and movement information representing a movement state of the ground processing machine, preferably speed information. Since it is generally to be expected that in the case of processing machines such as ground compactors, slippage that impairs position determination on the basis of steering information and movement information does not occur during operation, the current position or the path covered during the movement of the ground processing machine can also be determined very precisely in this way.

Particularly when compacting asphalt material, it is advantageous if a ground compactor is not moved in exactly along the same track during two consecutive passes in order to avoid the formation of edges in the transition to the even less compacted asphalt material. In order to be able to take this into account even in the partially automated steering of the ground processing machine, it is proposed that the control arrangement is designed to control the at least one steering actuator when moving in the second direction of movement on the basis of the path information for moving the ground processing machine with an offset to the path represented by the path information when moving in the first direction of movement.

Under certain circumstances, it may be necessary or advantageous to override the automated control of at least one steering actuator. In order to achieve this, the control arrangement can be designed to terminate the control of the at least one steering actuator on the basis of the path information when override information is present.

The override information can, for example, include steering intervention information representing a steering actuation of the steering element. If an operator operates the steering element during automated steering, for example, to an extent that exceeds a minimum amount of operation, the automated steering is terminated and the ground processing machine is again steered in accordance with the steering control performed by the operator. This can happen, for example, if a previously non-existent obstacle has to be avoided during ground processing. A deactivation of the control arrangement for controlling the at least one steering actuator on the basis of the deactivation function representing path information carried out by an operator can also form such override information.

According to a further aspect, the object mentioned at the outset is achieved by a method for operating a self-propelled ground processing machine, in particular a ground compactor, for example a self-propelled ground processing machine with the structure according to the invention, wherein the ground processing machine comprises a steering system with a steering element to be actuated by an operator and a control arrangement for controlling at least one steering actuator on the basis of an actuation of the steering element, wherein the method comprises the measures:
a) when the ground processing machine moves in a first direction of movement, generating path information representing the path covered when the ground processing machine moves in the first direction of movement,
b) when the ground processing machine moves in a second direction of movement substantially opposite to the first direction of movement, controlling the at least one steering actuator by means of the control arrangement on the basis of the path information.

In this method, measures a) and b) can be carried out repeatedly and alternately, so that an area of ground to be processed can be repeatedly driven over and processed at the same time. During these repeated passes, every second pass is carried out with an automated steering of the ground processing machine.

If measures a) and b) are repeatedly carried out one after the other, the first direction of movement when carrying out measure a) may differ from the first direction of movement when previously carrying out measure a). This makes it possible to process a comparatively large area of ground using the partially automated steering of a ground processing machine according to the invention.

In measure a), the control arrangement can control the at least one steering actuator on the basis of steering information representing an actuation of the steering element, so that in this phase of ground processing the steering takes place according to the instructions of an operator.

The recording of the path to be subsequently used as a reference for the automated steering of the ground processing machine can be initiated, for example, by starting the generation of the path information when generating a path information generation command in measure a). Such a path information generation command can be generated, for example, by actuation of a corresponding switching element by an operator.

If measures a) and b) are to be carried out repeatedly, it can further be provided that, in measure a), the generation of the path information is started when the direction of movement of the ground processing machine is reversed after movement of the ground processing machine in the second direction of movement during an immediately preceding implementation of measure b). The reversing of the direction of movement at the end of the implementation of measure b) indicates that the system is returning to a steering operation guided by an operator and that a reference for a subsequent automated steering operation can be generated again by generating the path information. It is then not necessary to manually start the provision of path information every time the carriage switches to operator-led steering operation.

In order to be able to avoid the movement of the ground processing machine in exactly the same track during two immediately consecutive passes in opposite directions, it is proposed that in measure b) the control arrangement controls the at least one steering actuator on the basis of the path information for moving the ground processing machine with an offset to the path represented by the path information when the ground processing machine moves in the first direction of movement when carrying out measure a).

The offset can be determined before carrying out measure b), preferably before carrying out measure a), for example before starting a ground processing operation. Furthermore, it is advantageous for a uniform machining result if the offset remains unchanged when carrying out measure b).

In order to initiate the automated steering operation without further manual interaction, it is proposed that measure b) be started when the direction of movement of the ground processing machine is reversed after the ground processing machine has moved in the first direction of movement and measure a) has been carried out immediately beforehand.

Since the existence of a reference defining the direction of movement is necessary for the implementation of the automated steering operation, it is further proposed that measure b) is terminated when, during the movement of the ground processing machine in the second direction of movement when measure b) is implemented, an end position of the ground processing machine is reached which is associated with a start position of the ground processing machine when measure a) was implemented immediately beforehand.

In order to ensure that the ground processing machine continues to operate in an appropriate manner when this end position is reached, the following can be done during or/and after reaching the end position:
generating an indication indicating that the end position has been reached, preferably a visual indication or/and an acoustic indication or/and a vibration indication, or/and
the control arrangement controlling the at least one steering actuator on the basis of steering information representing an actuating position of the steering element.

On the one hand, this gives an operator the opportunity to reliably recognize that such an end position has been reached. On the other hand, the operator can be again given responsibility for steering the ground processing machine.

Furthermore, measure b) can be terminated when override information is generated, for example to avoid the occurrence of critical situations or to terminate ground processing operations in general.

For example, the override information can be generated by:
an operation of the steering device during implementation of measure b),

or/and
a deactivation of the control arrangement for controlling the at least one steering actuator on the basis of the path information.

For an operation that efficiently uses the automated steering of the ground processing machine, it can be provided that, during measure a), the path information to be used in an immediately subsequent implementation of measure b) is only generated if the ground processing machine has covered a predetermined minimum path length since the start of measure a). If the processing machine only covers a comparatively short distance, for example a few meters, this generally means that a suitable reference for the subsequent automated steering of the processing machine is not available.

In the method according to the invention, it is particularly advantageous if the control arrangement controls a drive system of the ground processing machine on the basis of driving information representing an actuation of a drive element when carrying out measures a) and b) and after completion of measure b). This means that during the implementation of measure b), as well as during the implementation of measure a), the control arrangement only takes over the steering of the ground processing machine taking into account the reference generated by means of the path information, but not the setting of the driving speed. Regardless of the direction of movement of the ground processing machine and regardless of whether it is automatically controlled or not, the operator is solely responsible for this, primarily for safety reasons.

The present invention is described in detail below with reference to the attached figures. In the figures:

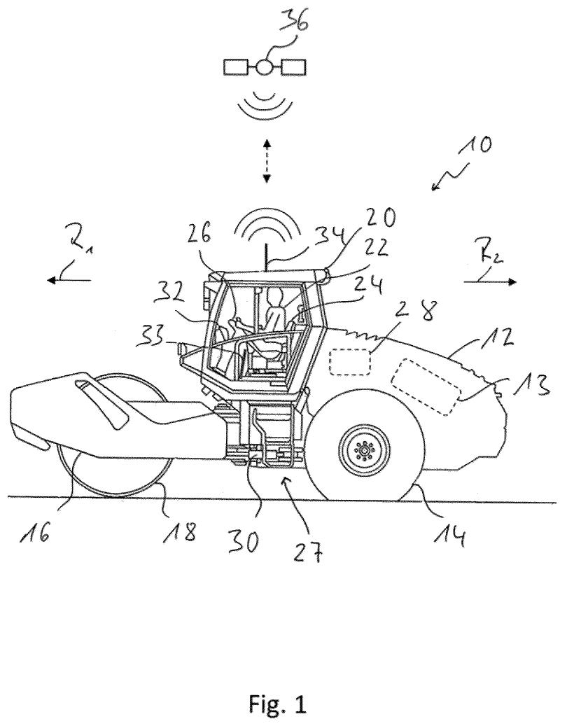

FIG. 1 shows a ground processing machine designed as a ground compactor;

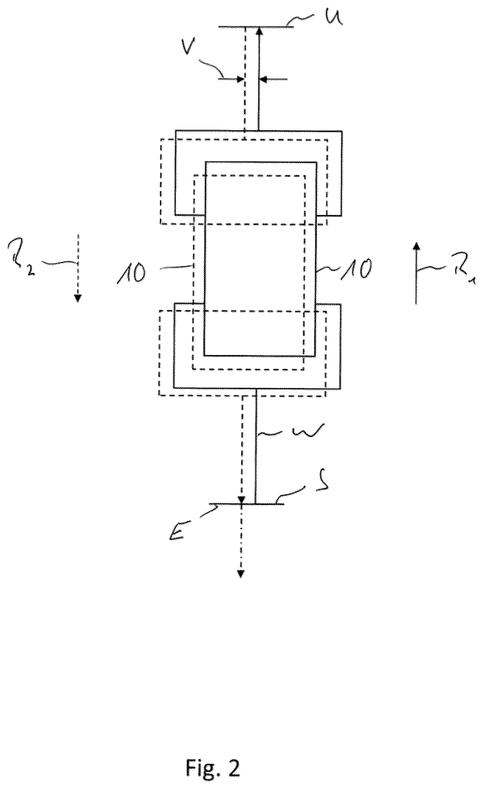

FIG. 2 shows a plan view in principle of a ground processing machine moving in two opposite directions of movement;

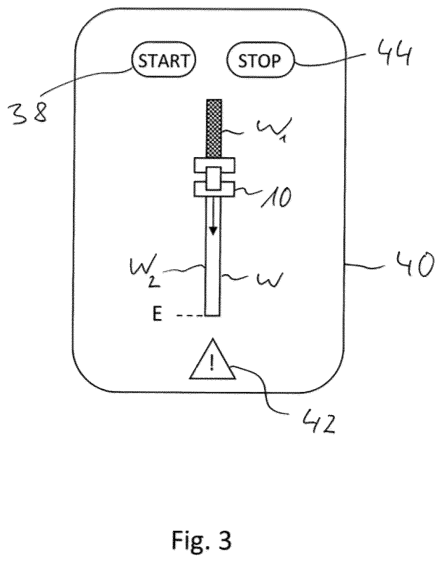

FIG. 3 shows a control/display unit designed as a touchscreen for a ground processing machine.

In FIG. 1, a ground processing machine designed as a ground compactor is generally designated by 10. In the exemplary embodiment shown, the ground processing machine 10 or the ground compactor comprises a rear carriage 12, on which a drive system 13 with a drive unit, for example a diesel internal combustion engine, is provided in order to rotatably drive traction wheels 14 positioned on both sides of the rear carriage 12. In an alternative embodiment, the ground processing machine 10 can also be operated by an electric motor and, for example, comprise an electro-hydraulic drive system 13.

A front carriage 16 is connected in an articulated manner to the rear carriage 12. A ground processing roller 18 is rotatably supported on the front carriage 16, so that when the ground processing machine 10 designed as a ground compactor moves over the ground B to be processed, for example over asphalt material to be compacted, the ground processing roller 18 rolls on the ground B and compacts it in the process.

Furthermore, a cabin 20 for an operator 22 is provided on the rear carriage 12. The operator 22 can sit on a seat 24 positioned in the cabin 20 when carrying out ground processing operations. When the operator 22 sits on the seat 24, he or she is oriented such that he or she faces forward, i.e. the first direction R₁ corresponding to a forward direction of travel.

In the cabin 20, various actuating elements for operating the ground processing machine 10 by the operator 22 are arranged. For example, a steering element 26 of a steering system 27 designed as a steering wheel can be actuated by the operator 22 in order to steer the ground processing machine 10. A steering sensor detecting the actuating position of the steering element 26 can introduce steering information representing this actuating position into a control arrangement generally designated 28. Based on the steering actuation or the signal of the steering sensor representing the corresponding steering information, the control arrangement 28 can control piston/cylinder units acting as steering actuators 30 between the front carriage 16 and the rear carriage 12. By extending or retracting these piston/cylinder units, the angle between the front carriage 16 and the rear carriage 12 can be changed and the ground processing machine 10 can thus be steered.

In the cabin 20 of the ground processing machine 10, further actuating elements are provided, for example positioned in the area of a dashboard 32 or to the side next to the seat 24. For example, a drive element 33, also generally referred to as a driving lever, is provided, the actuation of which by the operator 22 controls the speed and also the direction of movement of the ground processing machine 10. A signal representing the actuation of this drive element 33 can also be introduced into the control arrangement 28, and this can control the drive system 13 of the ground processing machine 10 according to the direction and extent of the actuation of the drive element 33. If, for example, the travel actuating element 10 is displaced forwards, i.e. in the direction of the first direction of movement R₁, the ground processing machine 10 is driven to move in accordance with the extent of the displacement or pivoting of the drive element 33 in the forward direction of travel, i.e. the first direction of movement R₁. If the travel actuating element is displaced or pivoted backwards, the drive system 13 of the ground processing machine 10 is controlled by the control arrangement 28 according to the extent of the displacement or pivoting in order to move the ground processing machine 10 in a second direction of movement R₂ corresponding to a reverse direction of travel.

In order to be able to provide information about the position of the ground processing machine 10 when carrying out a ground processing operation, a position detection system 34 is provided, for example, on the cabin 20. The position detection system 34 can, for example, be designed for radio communication with a satellite-based position identification system 36, for example GPS, so that position information representing the current positioning of the ground processing machine 10 on the ground B to be processed can be provided at any time with high resolution.

Alternatively or additionally, the position detection system 34 can also be designed to communicate with a locally installed radio system in order to be able to obtain information about the position of the ground processing machine 10 through local radio communication. In a further alternative or additional variant, the position detection system 34 can be designed to determine the position of the ground processing machine 10 solely on the basis of information provided in the area of the ground processing machine 10 and representing the driving state of the same. For this purpose, for example, steering information representing the steering state of the ground processing machine 10 can be used. This steering information can, for example, be provided by the signal emitted by the steering sensor associated with the steering element 26. Furthermore, information representing the state of movement of the ground processing machine 10, in particular the speed of movement of the ground processing machine 10, can be used for this purpose, which can be derived, for example, from the rotation of the traction wheels 14. By linking the steering information and the movement information, the position of the ground processing machine 10 can be determined at any time, for example if the exact spatial position of the ground processing machine 10 is known at the start of a ground processing operation. From the steering information and the movement information, the path covered by the ground processing machine 10 when carrying out a ground processing process can also be determined or recorded without the exact position of the ground processing machine at the start of the ground processing process having to be known.

The implementation of a ground processing operation is described below with reference to FIGS. 2 and 3.

In the example illustrated in FIG. 2, a ground processing operation is to be carried out by means of the ground processing machine 10, which is constructed here with two ground processing rollers, starting from a starting position S, by moving the ground processing machine in the first direction of movement R₁. At the beginning of the ground processing process, i.e. for example when or before setting off from the start position S or when reaching the start position S with the ground processing machine 10 already moving essentially in the first direction of movement R₁, a path information generation command is generated by the operator 22 by pressing a start switch 38 on an operating/display unit 40 designed, for example, as a touchscreen. The operating/display unit 40 can, for example, be arranged in the area of the dashboard 32.

By actuating the steering element 26 and the drive element 33 by the operator 22, the ground processing machine 10 moves, starting from the starting position S, in the first direction of movement R₁, i.e., for example, a forward direction of travel, until a reversing position selected by the operator or a predetermined reversing position is reached. During the movement from the starting position S to the reversing position U, the path W covered by the ground processing machine 10 is recorded. This can be done, for example, on the basis of the position periodically recorded or determined during the movement of the ground processing machine 10 or/and by linking the steering information and the movement information. The path information generated by the control arrangement 28 can, for example, be stored in a rewritable memory present in the control arrangement 28.

When the reversing position U is reached, the operator 22 stops moving the ground processing machine 10 in the first direction of movement R₁ by actuating the drive element 33 accordingly.

Starting from the reversing position U, the ground processing machine 10 is subsequently to be moved back essentially along the same path W that was previously traveled when moving in the first direction of movement R₁. To move in a second direction of movement R₂ that is substantially opposite to the first direction of movement R₁, the operator 22 actuates the drive element 33 accordingly, so that the ground processing machine 10 is then driven in the reverse direction. The control arrangement 28 uses the path W recorded during the previous travel or the path information representing it at the start of the movement in the second direction of movement R₂ to control the steering actuators 30 such that the ground processing machine 10 is moved back, for example, exactly along the same path W that it previously covered during the movement in the first direction of movement R₁. Steering intervention by the operator 22 is not required in this phase of the ground processing process. The operator 22 merely specifies the driving speed by corresponding displacement or pivoting of the drive element 33. For example, it can also be provided that the operator 22 specifies whether and to what extent a vibration generating mechanism is to be activated on one or both ground processing rollers.

When moving along the previously traveled path W, the ground processing machine 10 reaches an end position E corresponding to the preceding starting positions S. The movement of the ground processing machine 10 along the path W on the basis of the path information representing it in the direction of the end position E can be displayed in a corresponding display of the operating/display unit 40. For example, the path W₁ already covered and the path W₂ still to be covered in the direction of the end position E can each be displayed as a path bar representing the length of this path.

If the ground processing machine 10, which is also illustrated in this display, reaches the end position E, this can be communicated to the operator 22 by means of a corresponding indication. This indication can be represented by a visually perceptible warning symbol 42, as illustrated in FIG. 3. Alternatively or additionally, an acoustic signal or/and a vibration indication can be generated. The generation of this indication can also begin shortly before the end position E is reached in order to ensure that when the end position E is reached, the operator 22 is ready to take over full control of the ground processing machine 10 again.

For this purpose, the control arrangement 28 is designed such that when the end position E is reached, the steering angle set at that moment is maintained unchanged, i.e. control of the steering actuators 30 which causes the adjustment of the same is omitted. At the same time, the steering function is transferred back to the steering element 26, so that when the end position E is reached, the operator 22 is again responsible for steering. For example, it can also be provided that when the end position E is reached and the automated steering process is terminated, the steering actuators 30 are controlled on the basis of the steering position of the steering element 26 present at that moment. Since also when moving in the second direction of movement R₂, the control arrangement 28 only automatically operates or controls the drive system 13 and not the steering system 27, there is no automated intervention in the control of the drive system 13 even after the end position E is reached. This is still controlled exclusively under the instruction of the actuation of the drive element 33 by the operator 22, so that, for example, if there is initially no change in the actuation of the drive element 33, the ground processing machine 10 can move beyond the end position E or the previous starting position S.

FIG. 2 illustrates that during the movement in the second direction of movement R₂ the ground processing machine 10 can be moved with a lateral offset V with respect to the path W covered during the preceding movement in the first direction of movement R₁. The introduction of such an offset V, the value of which can be in the range of a few centimeters, for example 5 to 10 cm, up to 1 meter or more, has the effect that the ground processing machine 10 does not process or compact exactly the same area of the ground B during immediately successive passes. In particular, when compacting asphalt material, the formation of edges in the transition to the area of ground B that has not yet been compacted or is less compacted is avoided.

The offset V can, for example, be specified or entered by the operator 22 before the start of the ground processing process, i.e. before the start switch 38 is actuated, but can alternatively also be represented by a fixed value. However, the offset V can also be entered immediately before the reversing position U is reached. If no offset V is entered or defined when the reversing position U is reached, the control arrangement 28 can move the ground processing machine 10 back in the second direction of movement R₂ exactly along the same path W that was traveled during the preceding movement in the first direction of movement R₁. Advantageously, an offset V once specified remains unchanged during the movement in the second direction of movement R₂ from the reversing position U to the end position E.

At or after reaching the end position E, the ground processing machine 10 is brought to a standstill again by corresponding actuation of the drive element 33. By actuating the drive element 33 in such a way that the ground processing machine 10 again moves in the forward direction, i.e. the first direction of movement R₁, and with the start switch 38 still being actuated, the path W covered during this movement is again recorded with the reversing of the direction of movement or the start of the renewed movement in the first direction of movement R₁. Since the ground processing machine 10 is again steered by the operator 22 during this movement, it is possible that the path W covered during the second or each subsequent travel in the first direction of movement R₁, i.e. the forward direction of travel, does not exactly correspond to the path W covered during a previous travel in this direction of movement. This makes it possible to reach a larger area of the ground to be processed or compacted in a large number of consecutive passes.

After reaching a reversing position U again and actuating the drive element 33 such that the ground processing machine 10 moves back again in the second direction of movement R₂, the ground processing machine 10 can then be moved again under the automatic steering by means of the control arrangement 28 along the path W covered during the immediately preceding movement in the first direction of movement R₁ until an end position E corresponding to the previous starting position S is reached.

This process can be repeated until the ground B to be processed has been worked to a sufficient extent, for example until it has been driven over with a previously determined number of passes, some of which may be offset from one another. Once this state is reached, the recording of the path W or the control of the steering actuators 30 by means of the control arrangement 28 can be terminated by actuating a stop switch 44. For example, the ground processing machine 10 can then be moved to another location to perform a ground processing operation there, or can be parked until another ground processing operation is performed.

The deactivation of the automated control of the steering actuators 30 can also take place if, for example, due to unforeseen events during the movement in the first direction of movement R₁ or the movement in the second direction of movement R₂, intervention by the operator 22 is required. This can then, for example, end the automated steering or the recording of the path by pressing the stop switch 44. If this occurs when the ground processing machine 10 is moving in the second direction of movement R₂, the control arrangement 28 terminates the control of the steering actuators 30, and the operator 22 is again responsible for the appropriate steering of the ground processing machine 10 by correspondingly actuating the steering element 26.

The automated steering along the previously recorded path when moving in the second direction of movement R₂ can, for example, also be terminated when a steering intervention is made by the operator 22. Such a steering intervention can be detected, for example, when the operator 22 operates the steering element with a predetermined minimum amount of actuation. This may be the case, for example, if an obstacle occurs and further movement of the ground processing machine 10 along the previously traveled path W could lead to a collision. With such a steering intervention, the control arrangement 28 ends the automated control of the steering actuators 30, and the operator 22 takes over the control of the ground processing machine 10 again by actuating the steering element 26.

In order to be able to carry out a defined movement of the ground processing machine 10 in the second direction of movement R₂ on the basis of a path W previously covered during the movement in the first direction of movement R₁, it can further be provided that such path information is only stored or made available as a reference if a predetermined minimum path length of, for example, 5 meters was covered during the movement in the first direction of movement R₁. If this minimum path length has not been reached, this can be indicated, for example, by a corresponding indication in the operating/display unit 40, so that the operator 22 can recognize that automated steering will not take place during the return movement in the second direction of movement R₂.

In an alternative embodiment or procedure, starting the recording of the path information may also require a corresponding path information generation command, for example by actuating the start switch 38, each time a transition from the movement in the second direction of movement R₂ to a movement in the first direction of movement R₁ occurs in case of multiple consecutive travels.

1. A self-propelled ground processing machine comprising:
a steering system with a steering element to be operated by an operator and at least one steering actuator,
a control arrangement for controlling the at least one steering actuator on the basis of an actuation of the steering element,
wherein the control arrangement is designed to:
when the ground processing machine moves in a first direction of movement, generate path information representing the path covered when the ground processing machine moves in the first direction of movement,
when the ground processing machine moves in a second direction of movement substantially opposite to the first direction of movement, control the at least one steering actuator on the basis of the path information.

2. The self-propelled ground processing machine according to claim 1,
further comprising a position detection system for providing position information representing a position of the ground processing machine during a movement of the ground processing machine, wherein the control arrangement is designed to generate the path in-formation based on the position information.

3. The self-propelled ground processing machine according to claim 2,
wherein the position detection system is designed to generate the position information by communication with a radio-based position identification system.

4. The self-propelled ground processing machine according to claim 1,
wherein the control arrangement is designed to generate the path information on the basis of steering information representing a steering state of the ground processing machine and movement information representing a movement state of the ground processing machine.

5. The self-propelled ground processing machine according claim 1,
wherein the control arrangement is designed to control the at least one steering actuator during movement in the second direction of movement on the basis of the path information for moving the ground processing machine with an offset to the path represented by the path information during movement in the first direction of movement.

6. The self-propelled ground processing machine according to claim 1,
wherein the control arrangement is designed to terminate the control of the at least one steering actuator on the basis of the path information when override information is present.

7. The self-propelled ground processing machine according to claim 6,
wherein the override information comprises steering intervention information representing a steering actuation of the steering element or/and a deactivation function representing a deactivation of the control arrangement for controlling the at least one steering actuator on the basis of the path information.

8. A method for operating a self-propelled ground processing machine the ground processing machine comprising a steering system with a steering element to be actuated by an operator and a control arrangement for controlling at least one steering actuator on the basis of an actuation of the steering element, the method comprising:
a) when the ground processing machine moves in a first direction of movement, generating path information representing the path covered when the ground processing machine moves in the first direction of movement,
b) when the ground processing machine moves in a second direction of movement substantially opposite to the first direction of movement, controlling the at least one steering actuator by the control arrangement on the basis of the path information.

9. The control method according to claim 8,
wherein measures a) and b) are repeatedly carried out alternately.

10. The control method according to claim 9,
wherein when measure a) is carried out repeatedly, the first direction of movement can deviate from the first direction of movement during a previous implementation of measure a).

11. The method according to claim 8,
wherein in measure a) the control arrangement controls the at least one steering actuator on the basis of steering information representing an actuation of the steering element.

12. The method according to claim 8,
wherein in measure a) the generation of the path information is started upon generation of a path information generation command.

13. The method according to claim 9,
wherein measure a) the generation of the path information is started when the direction of movement of the ground processing machine is reversed after movement of the ground processing machine in the second direction of movement during an immediately preceding implementation of measure b).

14. The method according to claim 8,
wherein in measure b) the control arrangement controls the at least one steering actuator on the basis of the path information for moving the ground processing machine with an offset to the path represented by the path information when the ground processing machine moves in the first direction of movement when carrying out measure a).

15. The method according to claim 14,
wherein the offset is determined before carrying out measure b), or/and that the offset remains unchanged when carrying out measure b).

16. The method according to claim 8,
wherein measure b) is started when the direction of movement of the ground processing machine is reversed after movement of the ground processing machine in the first direction of movement during an immediately preceding implementation of measure a).

17. The method according to claim 8,
wherein measure b) is terminated when, during movement of the ground processing machine in the second direction of movement when carrying out measure b), an end position of the ground processing machine associated with a start position of the ground processing machine during an immediately preceding execution of measure a) is reached.

18. The method according to claim 17,
wherein upon or/and after reaching the end position:
an indication indicating that the end position has been reached is generated
or/and
the control arrangement controls the at least one steering actuator on the basis of steering information representing an actuating position of the steering element.

19. The method according to claim 8,
wherein measure b) is terminated when override information is generated.

20. The method according to claim 19,
wherein the override information is generated by:
an actuation of the steering element during implementation of measure b),
or/and
a deactivation of the control arrangement for controlling the at least one steering actuator on the basis of the path information.

21. The method according to claim 8,
wherein during measure a), the path information to be used during an immediately subsequent implementation of measure b) is only generated if the ground processing ma-chine has covered a predetermined minimum path length since the start of measure a).

22. The method according to claim 8,
wherein the control arrangement controls a drive system of the ground processing machine on the basis of driving information representing an actuation of a drive element during the implementation of measures a) and b) and after the completion of measure b).
